(19) United States
(12) Patent Application Publication
(10) Pub. No.: US 2011/0046988 A1
(43) Pub. Date: Feb. 24, 2011

(54) AUTOMATED TAXI DISPATCHING SYSTEM USING TELEPHONE NETWORKS

(76) Inventor: Peter John Gosney, Black Rock (AU)

Correspondence Address: BIRCH STEWART KOLASCH & BIRCH, PO BOX 747, FALLS CHURCH, VA, 22040-0747, US

(21) Appl. No.: 12/867,021

(22) PCT Filed: Feb. 10, 2009
(86) PCT No.: PCT/AU2009/000151

§ 371 Date: Nov. 9, 2010

(30) Foreign Application Priority Data
Feb. 12, 2008 (AU) 2008900652

(51) Int. Cl. G06Q 10/00

(52) U.S. Cl. 705/5

(57) ABSTRACT

A vehicle for hire request system and method are provided and operate via a telephone network. A plurality of independent vehicle hire entities (A,B,C,D,E) participates and each has its own plurality of vehicles for hire. A unique telephone number is provided for use by an intending hirer so that when called a request for a vehicle for hire can be processed through a trigger component (2). The trigger component (2) then conveys substantially simultaneously a request by the intending hirer to each of the plurality of independent vehicle hire entities (A,B,C,D,E). A unique response component is arranged to receive a first acceptance from an entity for the request vehicle hire and to trigger a cancellation of the request from all remaining entities. An acceptance response is then conveyed to the intending vehicle hirer.

### FIELD OF THE INVENTION

This invention relates to a system that has particular although not exclusive application in a taxi vehicle for hire environment.

### BACKGROUND ART

Hitherto, systems have been proposed for use with taxi hire environments to enable taxis to be booked using a telephone system. Typically, a hirer will telephone a particular number of a taxi company and the taxi company will respond informing the hirer that the booking has been placed and that the expected time of arrival will be provided shortly. Whilst such systems have proven successful to some fleets of taxis, there are a number of shortcomings. Shortcomings can be appreciated when a taxi hire company is a single entity amongst a multitude of entities that each have their own taxi fleets. In such cases, one or more of the taxi entities may have purchased premium advertising space to display their dedicated telephone number more prominently than others. This gives rise to unfairness claims by the remaining entities. Moreover, if a hirer telephones a particular taxi hire entity and makes a booking with that taxi hire entity, the hirer may have been able to obtain a faster service had he made or attempted a booking with a different hiring entity.

### OBJECT AND STATEMENTS OF THE INVENTION

The present invention attempts to address one or more of the above problems as well as other problems.

Therefore, according to a first broad aspect of the present invention there is provided a vehicle for hire request system for operation via a telephone network, said system having a plurality of fleets of independent vehicle hire entities each with their own plurality of vehicles for hire, said system including a system unique telephone number to which intending hirers can telephone and be connected with a trigger component to request a vehicle, said trigger component permitting relaying of a telephoned request for vehicle hire by an intending hirer to be conveyed substantially simultaneously to said plurality of entities,
an entity response component arranged to receive a first acceptance from an entity of an intending hirer's request for vehicle hire and to trigger a cancellation of the request for vehicle hire from all remaining entities, and to convey an acceptance response to the intending hirer.

In one example, the telephone network is a mobile telephone network with Caller Line Identification (CLI) and wherein an intending hirer's CLI is extracted at the time the intending hirer telephones a request for a vehicle for hire and wherein said trigger component provides an acknowledgement of the request for a vehicle to hire to the hirer and then hangs up, and
wherein when said first acceptance of the intending hirer's request for vehicle hire is received by said entity response component the hirer's extracted CLI is used to enable a confirmation of availability of booking to be given to the intending hirer.

In an example said confirmation of availability of booking is an SMS message to the intending hirer.

In an example confirmation of availability of booking includes an identifier by which the intending hirer can recognise the vehicle assigned to the booking and an estimated time of arrival (ETA).

In an example the intending hirer conveys a pick-up location to the system at the time the request for a vehicle for hire is made. This may be undertaken initially or at some later point in the booking process.

According to a further broad aspect of the present invention there is provided a method of enabling an intending hirer of a request for hire vehicle to book a first available vehicle from a plurality of fleets of vehicles from for hire entities via a telephone network,
said method comprising providing a trigger component in the network, said trigger component being accessible to an intending hirer by dialling a system unique telephone number to request a vehicle, having the intending hirer telephone the unique telephone number, and using the trigger component to convey the request for booking to all the entities substantially simultaneously,
providing an entity response component in the network,
having the entities able to provide an acceptance of the intending hirer's request, and on receiving a first acceptance of an intending hirer's request for vehicle hire, activating the entity response component to trigger a cancellation of the request for vehicle hire from all remaining entities,
and conveying an acceptance response to the hirer.

### BRIEF DESCRIPTION OF DRAWINGS

In order that the invention can be more clearly ascertained, an example of an embodiment will now be described with reference to the accompanying drawings wherein:

FIG. 1 is a block schematic functional diagram of process steps in one preferred system, and

FIG. 2 is an overview block schematic circuit diagram showing components in a telephone network for implementing the system shown in FIG. 1.

### DETAILED DESCRIPTION OF EMBODIMENT

It should be appreciated that the present invention is applicable to a vehicle for hire request system and method that enables a first available vehicle from a plurality of fleets of vehicles to be booked. Whilst the invention has been described as a vehicle for hire request system and method, it should be appreciated that the vehicles are not confined to taxi use but may be to any use whatsoever such as delivery trucks, machinery mounted on vehicles, concrete delivery vehicles and the like.

The present embodiment will be described in relation to a vehicle for hire request system specifically for use when booking a taxi.

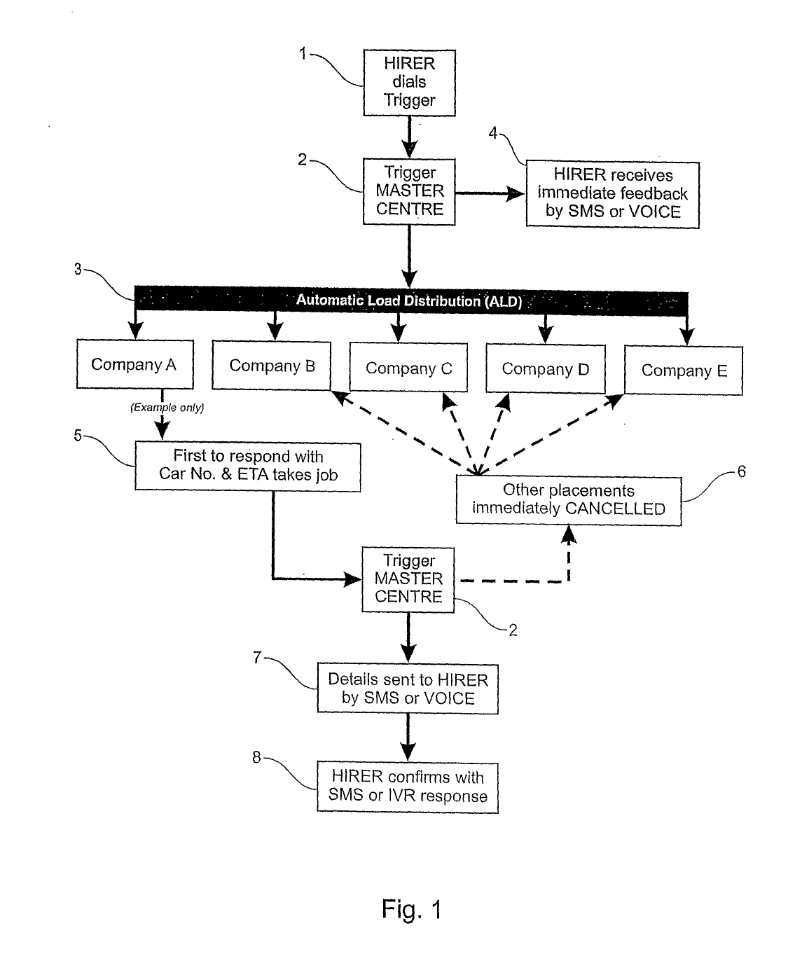

Referring firstly to FIG. 1, there is shown that a hirer dials a unique telephone number for the system to indicate a request for a vehicle for hire. All potential hirers can dial the same unique telephone number. The invention has particular application at busy terminals such as airport terminals or train stations where persons unfamiliar with a particular city can easily find a prominently displayed single unique telephone number from which to order a vehicle for hire.

The hirer dials the unique telephone number and this, in turn, connects with a trigger component at step 2. The trigger component substantially simultaneously provides a request to a plurality of independent vehicle hire entities indicated by company A, company B, company C, company D, and company E. These are identified as being interconnected with the trigger component 2 via an Automatic Load Distribution component 3. Substantially simultaneously to the dispatch of the request for vehicle hire signal to each of the company's A, B, C, D, and E, the trigger component 2 dispatches a message to the hirer to indicate that an order has been received and is being placed. This occurs at step 4. The message may be a voice message or it may be an SMS telephone message. Typically, the hirer will dial into the trigger component using a telephone facility with a Caller Line Identification (CLI). If this is a land line phone then the CLI can be used to pin point the location from which the hirer has requested the vehicle for hire. If it is a mobile phone then either a voice or an SMS message may be returned. The hirer may be requested to hang-up upon receiving the SMS or voice message at step 4.

Accordingly, it can be seen that all of the independent vehicle hire entities A, B, C, D and E have received a request for vehicle for hire substantially simultaneously by the intending hirer placing a single call to a unique telephone number.

In the example described, company A is the first of the companies to respond to the hirer's request for a vehicle. This is shown at step 5. The response from company A is dispatched to the trigger component 2 and the trigger component 2 triggers a cancellation of the request for vehicle hire from all remaining entities. This is shown at step 6. The trigger component 2 also sends an acceptance response to the intending hirer as shown at step 7. This acceptance response may be by SMS or voice using the extracted CLI from the hirer. At step 8, the hirer confirms that the booking is to be made firm with the vehicle for hire entity.

When a first acceptance from an entity of an intending hirer's request responds at step 5, the response can include a vehicle number and an estimated time of arrival (ETA). This information can be sent to the hirer at step 7 so that the hirer can make a decision whether to make the booking firm or not.

Whilst the above arrangement contemplates that the hirer hangs up the telephone upon making a request for vehicle hire, the system may be configured to allow the intending hirer to remain on line until the transaction has been completed at step 8. This will enable the processing of an intending hirer's call where a CLI is not present.

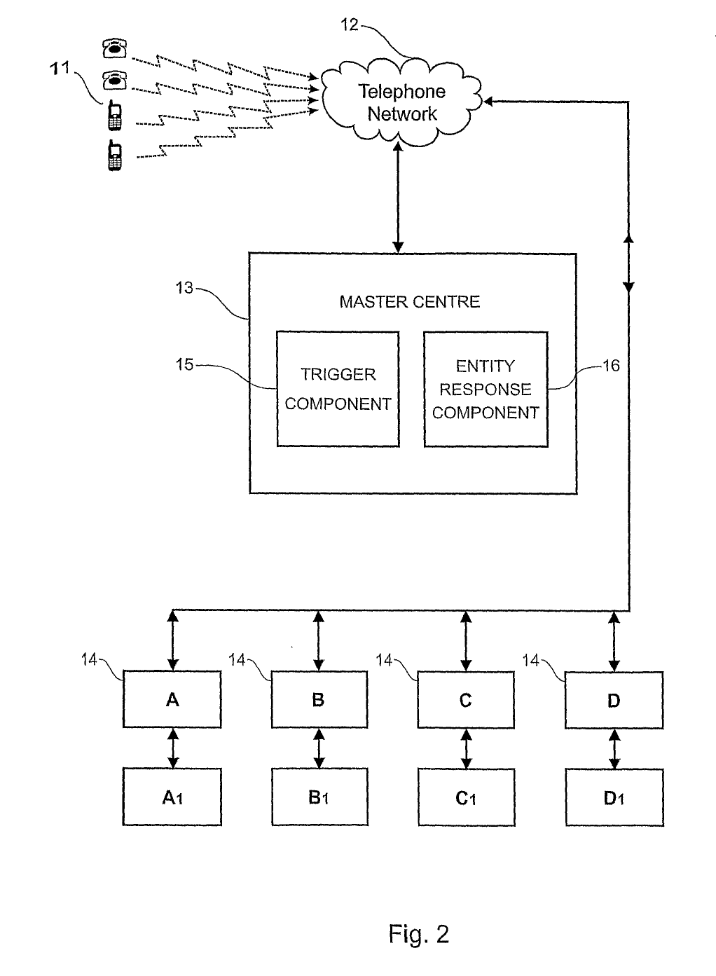

FIG. 2 is a block circuit upper level schematic diagram showing components in the system. Here, there are a number of telephones 11 by which intending hirers can request a vehicle for hire. Some of these telephones may be land line telephones and some may be mobile telephones. The telephones interconnect to the system through the telephone network 12 which, in turn, is connected with a master centre 13 and each one of the independent vehicle hire entities A, B, C, D, shown at 14. The master centre 13 includes a trigger component 15 and an entity response component 16. Thus, a phone call from an intending hirer is made via the network 12 to a particular telephone number which connects with the master centre 13. The incoming call operates the trigger component 15 via the Automatic Load Distribution 3 referred to in FIG. 1 to provide the request for vehicle for hire substantially simultaneously to each of the independent vehicle hire entities 14. This connection is also via the telephone network 12. Thus, each of the independent vehicle hire entities 14 receive the request signal substantially simultaneously and each have the same opportunity to accept. The first entity 14 that accepts provides a response through the telephone network 12 to the master centre 13 to the entity response component 16 which triggers a cancellation of the request for vehicle hire from all remaining entities and then conveys an acceptance response to the intending hirer via the telephone network 12.

As stated previously, the particular unique telephone number dialled by the intending hirer may indicate the location for pick-up of the intending hirer, or the intending hirer may be requested by the trigger component or the entity response component to input data to indicate the pick-up location. This may be a code number entered post making the initial request for a vehicle for hire. Alternatively, it may be made at the same time by including the data with the transmitted call. For example, the unique telephone number may be no. 1400 000. This may indicate a call coming from a capital airport. The last several digits of the telephone number can be assigned to indicate particular pick-up points. These pick-up points may be displayed at the curb side or some other convenient position. Thus, the intending hirer may dial the original unique number and then be requested to input data concerning the intending pick-up or alternatively, the intending hirer may be requested by the system to input data concerning the pick-up by adding extra digits during the call. In a variation the intending hirer may add the extra pick-up point digits into the call, so that when calling the unique number the last few digits indicate the pick-up point.

FIG. 2 shows that each of the independent vehicle hire entities 14 has its own fleet booking distribution system A1, B1, C1, D1 etc. Accordingly, each fleet of independent vehicle hire entities 14 may be able to allocate the booking to any one of its particular vehicles in its fleet. Alternatively, each of the vehicles within each of the independent vehicle hire entities may have direct access to the master centre 13 and be able to directly trigger a response to the entity response component 16. Each or some of the independent vehicle hire entities may have a feature in their own fleet booking distribution system to assign a booking to an available vehicle that is closest to the pick up point so that the shortest pick up time can be realised.

The system may be enhanced by providing that in the event of the intending hirer not making the booking firm at step 8 (see FIG. 1)—that the system then prompts the intending hirer “would he like to request a further vehicle for hire”. This would be on the assumption that the ETA of the first response vehicle is unsatisfactory. In that event, the system may be arranged to cancel any booking for the first to respond, and then reassign the booking to all of the entities 14 once again to see the response time. The hirer then has the opportunity of accepting the vehicle most suited to the hirer's needs.

It should also be appreciated that a code number may be included within the unique telephone number to be dialled to indicate a type of vehicle required. For example, a particular number may indicated a maxi cab whereas the absence of such number may indicate any cab.

In addition, personal profiles of the hirer may be able to be determined by including particular codes within the number dialled or any subsequent numbers that are entered into the system. This can indicate a possible number of persons for collection or a particular final destination.

If an intending hirer makes a booking for a hire vehicle and the ETA time is different to the actual ETA time then the intending hirer may telephone a further particular telephone number to lodge a complaint. In this way, each of the independent fleet of hire entities will be required to ensure they process any first acceptance requests accurately, otherwise they may be blacklisted and excluded from the system.

Modifications may be made to the invention as would be apparent to persons skilled in the art of communication. For example, unique telephones such as mobile telephones may be provided to international travellers at the point of arrival at an airport terminal. These may be provided for a small fee and have a minimum number of operator buttons to permit connection directly with the vehicle for hire request system. These and other modifications may be made without departing from the ambit of the invention the nature of which is to be determined from the foregoing description.

It is to be understood that, if any prior art publication is referred to herein, such reference does not constitute an admission that the publication forms a part of the common general knowledge in the art, in Australia or any other country.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1.-9. (canceled)

10. A vehicle for hire request system for operation via a telephone network for use by vehicle for hire non system registered intending hirers, said system having a plurality of fleets of independent vehicle hire entities each with their own plurality of vehicles for hire, said system including a system unique telephone number to which intending hirers can telephone and be connected with a trigger component to request a vehicle, said trigger component permitting relaying of a telephoned request for vehicle hire by an intending hirer to be conveyed substantially simultaneously to said plurality of entities,
an entity response component arranged to receive a first acceptance from an entity of an intending hirer's request for vehicle hire and to trigger a cancellation of the request for vehicle hire from all remaining entities, and to convey an acceptance response to the intending hirer.

11. A system as claimed in claim 10, wherein the telephone network is a mobile telephone network with Caller Line Identification (CLI) and wherein an intending hirer's CLI is extracted at the time the intending hirer telephones a request for a vehicle for hire and wherein said trigger component provides an acknowledgement of the request for a vehicle to hire to the hirer and then hangs up, and
wherein when said first acceptance of the intending hirer's request for vehicle hire is received by said entity response component the hirer's extracted CLI is used to enable a confirmation of availability of booking to be given to the intending hirer.

12. A system as claimed in claim 11, wherein said confirmation of availability of booking is an SMS message to the intending hirer.

13. A system as claimed in claim 12, wherein said confirmation of availability of booking includes an identifier by which the intending hirer can recognise the vehicle assigned to the booking and an estimated time of arrival (ETA) of the vehicle.

14. A system as claimed in claim 11, wherein the intending hirer is requested to confirm the booking before the booking is made firm with the entity, and wherein upon a confirmation being received the booking is then made firm with the entity.

15. A system as claimed in any one of the preceding claims, wherein the intending hirer conveys a pick-up location to the system at the time the request for a vehicle for hire is made.

16. A system as claimed in claim 15, wherein the pick-up location is determined by the unique telephone number to which the intending hirer can telephone.

17. A system as claimed in claim 15, wherein the system has a single telephone number for all requests for booking, and wherein when said trigger component is activated by a request for vehicle hire by an intending hirer, a request is then made to the intending hirer to enter data concerning the pick-up location.

18. A method of enabling non system registered intending hirers to make a request for a hire vehicle and to book a first available vehicle from a plurality of fleets of vehicles from for hire entities via a telephone network,
said method comprising providing a trigger component in the network, said trigger component being accessible to an intending hirer by dialling a system unique telephone number to request a vehicle, having the intending hirer telephone the unique telephone number, and using the trigger component to convey the request for booking to all the entities substantially simultaneously,
providing an entity response component in the network,
having the entities able to provide an acceptance of the intending hirer's request, and on receiving a first acceptance of an intending hirer's request for vehicle hire, activating the entity response component to trigger a cancellation of the request for vehicle hire from all remaining entities,
and conveying an acceptance response to the intending hirer.
